(19) United States
(12) Patent Application Publication
(10) Pub. No.: US 2014/0236623 A1
(43) Pub. Date: Aug. 21, 2014

(54) SYSTEM AND METHOD FOR TRACKING CLINICAL TRIAL PARTICIPATION

(71) Applicant: CTSdatabase, LLC, Beverly Hills, CA (US)

(72) Inventor: Thomas Shiovitz, Beverly Hills, CA (US)

(73) Assignee: CTSdatabase, LLC, Beverly Hills, CA (US)

(21) Appl. No.: 14/350,308

(22) PCT Filed: Oct. 8, 2012
(86) PCT No.: PCT/US2012/059266

§ 371 Date: Apr. 7, 2014

Related U.S. Application Data
(60) Provisional application No. 61/544,421, filed on Oct. 7, 2011.

(51) Int. Cl. G06F 19/00

(52) U.S. Cl. CPC G06F 19/363; G06F 19/322
USPC 705/2

(57) ABSTRACT

A system and method for determining whether an individual is eligible to participate in a clinical trial by comparing partially identifying personal information of the subject to a database of partially identifying personal information of participants in other clinical trials and calculating the frequency of occurrence of the partially identifying personal information.

### BACKGROUND

Clinical trials often involve patients with specific health conditions who then benefit from receiving otherwise unavailable treatments. In early phases, participants are healthy volunteers who receive financial incentives for their participation, while in later phases test subjects are volunteers who have a medical condition in need of treatment. During the clinical trial, investigators recruit patients who meet a set of predetermined criteria for inclusion in the clinical trial. Subjects who are accepted into a clinical trial receive treatment according to a clinical trial protocol, and the investigators collect data on the subjects' responses to the treatment.

Clinical trials are commonly classified into four phases. Phase 1 involves screening a candidate drug or other treatment for safety. In this phase, healthy volunteers, who may be paid, are tested. In phase 2 of a clinical trial, a small number of subjects having a medical condition are tested in order to evaluate the efficacy of the treatment for that condition. If sufficient safety and efficacy are found in phase 2, then the trial proceeds to phase 3, in which a statistically significant number of subjects are treated. Phase 4 refers to a post marketing study to delineate additional information, including the treatment's risks, benefits, and optimal use.

The sponsor of a clinical trial, such as a pharmaceutical company, generally will contract with independent physicians, hospitals and/or companies that test drugs on human subjects to conduct portions of the clinical trial. These contractors will in turn recruit subjects (volunteers) and enroll them in the clinical trial. During the enrollment period of the study, the contractor will administer a test drug or other test treatment to subjects and record subjects' reactions to the treatment.

The observations recorded during a clinical trial generally include those relating to safety and to efficacy. One significant aspect of a clinical trial is the determination of whether subjects experience any adverse effects from taking a test drug or other treatment. Another aspect of the trial is determining whether the medical condition being treated is in fact being alleviated.

In most drug studies, subjects are specifically forbidden from being enrolled in multiple concurrent studies. If a subject is enrolled in a clinical depression study as well as a study for migraines, for example, the effect of the two drugs in combination may alter the observations being recorded at the site. Subjects also may be disqualified from participating in a clinical trial within a period of time after concluding participation in an earlier trial. On the other hand, some clinical trials, particularly during phase 1, will offer compensation for subjects to participate, and some subjects enroll in clinical trials to create a secondary source of income. This creates an incentive for participation in a clinical trial by inappropriate subjects, such as subjects participating concurrently in other clinical trials, and has resulted in the invalidation of entire clinical studies.

### SUMMARY

The present method addresses the problem of clinical trial participation by subjects who are concurrently participating in other trials or who are otherwise ineligible by creating a database used by clinical trial service providers to screen potential clinical trial participants in order to determine whether they are concurrently participating in other clinical trials. The present method, which is operational in a computer system, comprises receiving personal identifying information obtained from a subject proposed for inclusion in the first clinical trial. This personal identifying information includes:
(i) the initials of the subject, wherein the initials comprise the first letter of a first name of the subject, the first letter of a middle name of the subject, and the first letter of a last name of the subject;
(ii) the day, month, and year of birth of the subject;
(iii) 4 consecutive characters of a verified identification; and
(iv) the height and gender of a study participant;

The height and gender of the proposed subject are compared to height and gender information in a database for subjects participating in one or more other clinical trials. Preferably, the height of the subject and that of another clinical trial participant are found to match if the heights are within 5 centimeters of each other. If the height and gender of the proposed subject matches the height and gender of one or more enrolled clinical trial subjects, then the following personal identifying information of the proposed subject are compared with corresponding personal identifying information of the enrolled clinical trial subjects:
(i) first initial;
(ii) second initial;
(iii) last initial;
(iv) day and month of birth;
(v) year of birth; and
(vi) four consecutive digits of an alphanumeric identifier of a verified identification.

If all these items of personal identifying information of the proposed subject match the same items of personal identifying information of an enrolled clinical trial subject, then the subject can be deemed a virtually certain match with another clinical trial study participant in the database. If some of the items of personal identifying information of the proposed subject listed above do not match the same items of personal identifying information of an individual enrolled clinical trial subject, then frequency information for each of these items of personal identifying information is obtained from a predetermined data set. The frequency information includes the following:
(i) frequency of first initial of a subject as either the first initial or second initial of an enrolled clinical trial subject;
(ii) frequency of middle initial of a subject as either the first initial or second initial of an enrolled clinical trial subject;
(iii) frequency of last initial of a subject as last initial of an enrolled clinical trial subject;
(iv) frequency of day and month of birth of a subject;
(v) frequency of year of birth of a subject;
(vi) frequency of gender; and
(vii) frequency of four consecutive alphanumeric digits used in an alphanumeric identifier of a verified identification;

The frequency information for each of the items of personal identifying information of the proposed subject which match the same items of personal identifying information of an enrolled clinical trial subject is then multiplied together, and if the product of these frequencies is <0.00001, then the subject is identified as possibly matching a clinical trial subject participating in one or more other clinical trials. Preferably, the subject is found to be a match with an individual in the database if the product is between 0.00001 and 0.0000001, and even more preferably if the product is <0.000001.

The foregoing method can be implemented by a computer system, such as a desktop computer or a server, that preferably comprises a display device, a communication interface, and a processing circuit coupled to the display device and the communication interface, the processing circuit being adapted to receive data and perform the present method. The computer system can include a memory or other storage medium, and the memory or storage medium can be encoded with computer readable program code comprising instructions operable to perform the present method.

### FIGURES

FIG. 1 is a diagram illustrating an embodiment of the present process for identifying individuals ineligible to enroll in a clinical trial.

FIG. 2 is a diagram illustrating an embodiment of the search methodology used in the present process.

FIG. 3 is an illustration of an interface for use in entering information to be screened in the present process.

FIG. 4 is a table listing the possible combinations of a subject's initials being searched in the present process.

FIG. 5 is table listing the possible combinations of matches of a subject's initials with the subject's date of birth information and verified document information for purposes of being searched in the present process.

FIG. 6 lists tables showing the frequency of female height by age.

FIG. 7 is a table showing the number of subjects found to ineligible to enroll in clinical trials in the CNS area in a particular region.

### DESCRIPTION

### Definitions

As used herein, the following terms and variations thereof have the meanings given below, unless a different meaning is clearly intended by the context in which such term is used.

“Adapted to,” in regard to a processing circuit, refers to the processing circuit being configured, employed, implemented, or programmed, as well as any combination thereof, to carry out some process, function, step or routine.

“Clinical trial” refers to the testing of a drug, medical device, or other therapeutic treatment on human subjects. During clinical trials tests are performed in order to evaluate the safety and efficacy of the treatment in connection with a medical condition. Clinical trials generally are performed at a number of different sites, including hospitals and other physical locations suitable for medical testing.

“Clinical trial service provider” refers to an individual, organization, or other legal entity which conducts some or all of a clinical trial for a clinical trial sponsor. Clinical trial service providers are generally physicians, hospitals or companies specializing in conducting clinical trials.

“Computer system” refers to any electronic data processing device adapted to execute software and that is adapted to communicate via a communication network. By way of example and not limitation, a computer system can include a desktop computer, a laptop computer, a notebook computer, a tablet (e.g., iPAD®), a server, or other data processing device.

“Exclusion criteria” refer to predetermined conditions or standards which do not meet or are outside of the inclusion criteria (defined below). Exclusion criteria also include predetermined conditions or standards that make a subject ineligible to participate in a particular clinical trial.

“Frequency,” in reference to the information in the clinical trial database used in the present method, refers to the number of times that a piece of data appears as compared to the total number of data items. For example, the frequency of a particular four digit number appearing in a set of all numbers (using a decimal numeral system) is 1 in 10,000 or 0.0001.

“Inclusion criteria” refer to predetermined conditions that must be met by a subject in order for the subject to be eligible to participate in a particular clinical trial, i.e., the standards used to determine whether the subject allowed to participate in the clinical trial.

“Medical condition” refers to a disease, disability, or other condition of a subject which is recognized by medical experts.

“Product,” with reference to the present process, refers to the result obtained by multiplying two or more quantities together, in particular quantities corresponding to frequency information.

“Sponsor” refers to the individual, organization, or other legal entity which contracts with or otherwise engages a clinical trial service provider to perform some or all of the testing involved in a clinical trial.

“Subjects” refer to individuals who are proposing to participate in or who are participating in a clinical trial, particular human subjects.

“Verified identification” refers to a form of identification issued by a government agency or other certifying entity which can only be obtained based upon documents, records, biometric data, or other information which verifies the identity of the individual receiving such verified identification. Such proof can include a birth certificate, government-issued identity card, or other form of proof. For purposes of the present method and system, a verified identification comprises a series of at least four numbers or other alphanumeric characters, preferably 7 or 8 characters, and even more preferably at least 9 numbers or other characters.

The term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise.

### Screening Process

Screening for concurrent participation in clinical trials by subjects, or for participation by ineligible subjects, is difficult due to regulations in many jurisdictions which protect the privacy of individuals in medical settings, such as the HIPAA (Health Insurance Portability and Accountability Act of 1996) regulations in the United States, as well as due to the provision of false or incomplete information by clinical trial subjects. In order to accurately screen for ineligible clinical study participants, the present process makes use of partial identifiers of a subject's identify, such as a subject's initials, birth date, or physical data (height, gender, etc.). The present process uses partial identifiers to produce matches to existing entries in a database of clinical trial participants, and to identify such matches as being possible, probable or virtually certain.

The database used in the present process (referred to herein as the “clinical trial database”) is one in which includes personal information data (i.e., the search parameters described below) concerning participants in a plurality of clinical trials. Preferably, the database includes both clinical trials which are ongoing at the time that a subject presents himself or herself for participation in a particular clinical trial, as well as clinical trials which have concluded. This is because the subject's participation in a concluded clinical trial may make that subject ineligible for the later clinical trial, either because the subject's participation was too recent or because the subject left the earlier trial for a particular reason, if these factors are exclusion criteria for the clinical trial that the subject proposes to participate in.

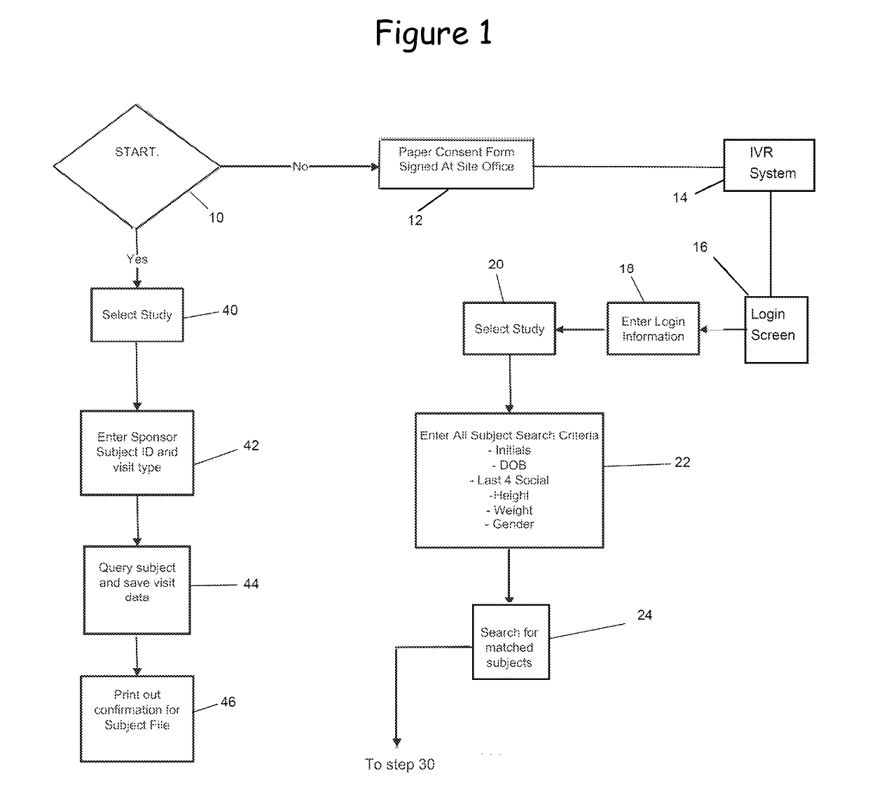

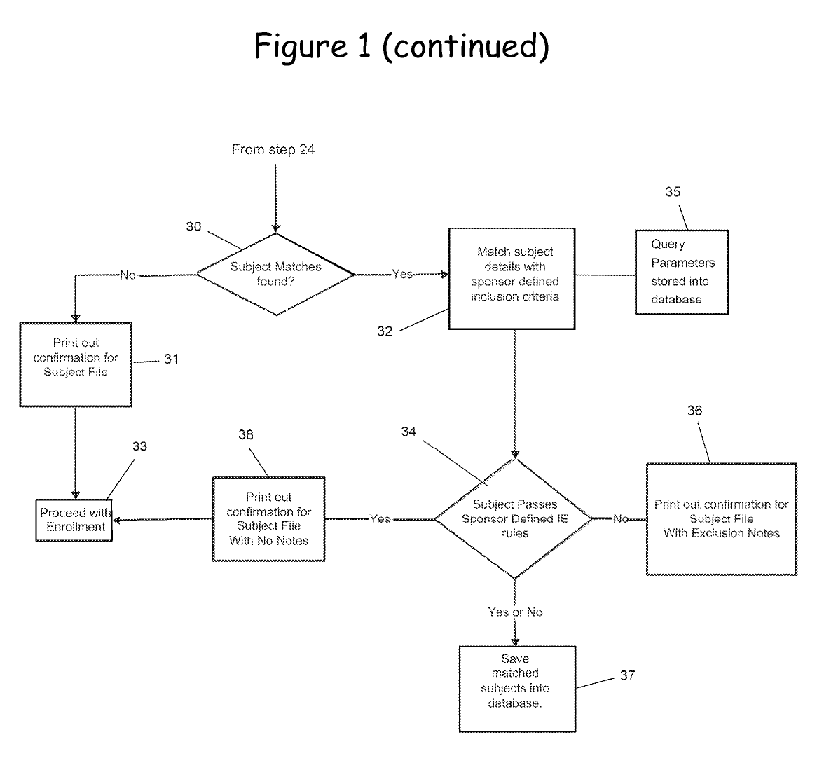

FIG. 1 provides an overview of the present process. The process starts at decision point 10 in FIG. 1, when a subject arrives at the site. The first step is to determine whether this is a brand new subject coming in to enroll into a study or whether this is a subject that has already been enrolled into a study and is here for a repeat visit. The key visits are the first and the last, as these two dates will indicate whether a subject is currently enrolled in a study and in which study.

The first visit is when the subject is enrolled into a study after determining that he or she has passed all the inclusion criteria specified by the sponsor. The last visit can occur in different ways. Optimally, the subject finishes the entire study. Another option is for the subject to end the study early, either by the subject's choice or due to the decision of a physician or other medical expert. Information regarding the first and last dates of participation in a clinical trial by a subject is included in a database of the present system, as this data will allow the system to determine whether the subject is eligible to participate in another study.

If the subject is a brand new subject, the process flow in FIG. 1 proceeds to the right and downward from block 10. The first step completed before any further interaction with the subject can generally take place is for the subject to sign an informed consent form (block 12). This document informs the subject of all the risks involved in enrolling in a clinical trial and obtains consent from the subject to perform all the activities set out in the protocol. In an alternative embodiment, a subject proposing to participate in a clinical trial can be prescreened before signing an informed consent document by using information provided by the proposed clinical trial participant to search for matches in a database of other clinical trial participants, as described further below.

Once informed consent has been obtained from the subject, the clinical trial service provider preferably obtains a sponsor subject identity code (referred to as Sponsor Subject ID) in order to uniquely identify the subject in the clinical trial. This can be done, for example, by calling an IVR (Integrated Voice Response System, block 14). Once a Sponsor Subject ID is obtained, the user of the present system logs into the system using a login screen (blocks 16 and 18). After login, the user is asked to select which study the subject is enrolling in (block 20), since a particular clinical study site may have several studies associated with it in the system. Next, the user enters the query parameters to be searched in the database (block 22) in order to identify possible matches (e.g., subjects participating in other clinical trials) corresponding to the subject.

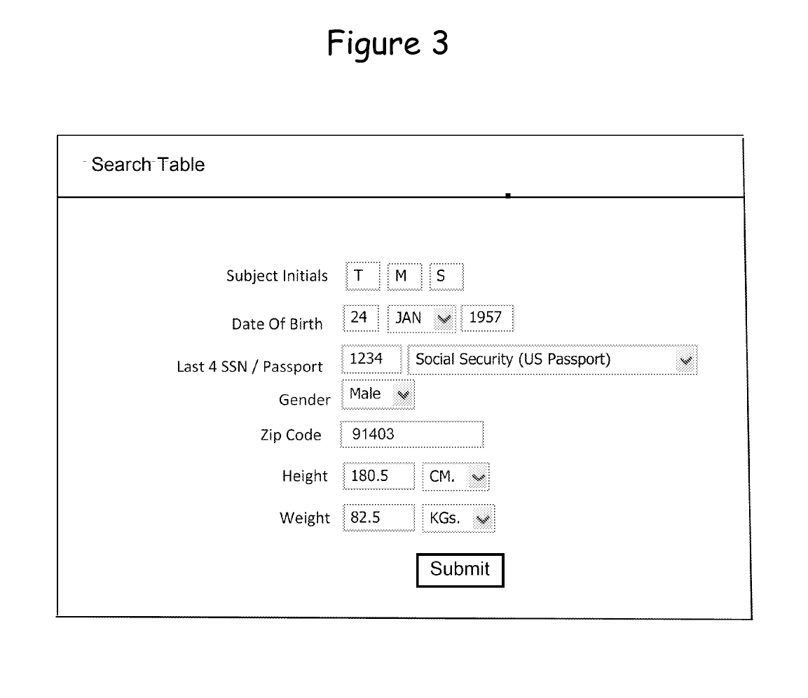

Six parameters or criteria to be searched are shown in block 22, as well as in FIG. 3, which shows an embodiment of a search screen of the present system. These parameters (described further below) include a subject's initials, date of birth, social security number (or other validated identification indicia), height, weight, and gender. The parameter information is entered and submitted for search into the database (block 22). Once the information is submitted, this information can be stored into the clinical trial database of the present system, along with all other connected data. In the process illustrated in FIG. 1, this information is stored following the identification of matches using the present method (block 35).

The parameter information is subjected to a search process (block 24) on a server or other processor-driven device, to determine if any subjects listed in the database match the current subject. If no matches are found (block 30) in the database against the entered search parameters, the system generates and sends a communication to the user (block 31) confirming that the clinical trial service provider can proceed with enrolling the subject in the clinical trial (block 33).

If matched records are found (block 30), the system will assign each matched record a specific match status (e.g., probable match, almost certain match, etc.). All matched records will then be submitted to another process to compare these records with the inclusion criteria established for the clinical trial (blocks 32, 34). If a subject does not meet these inclusion criteria, for example a criterion that the subject not be participating in another clinical trial concurrently, then the subject will be excluded from the trial, and a communication will be generated indicating this (block 36). If the subject meets the inclusion criteria, then a communication to this effect will be generated (block 38) and the subject may proceed with enrollment (block 33). All query results, whether they return matched subjects or not, are stored in the database (block 37).

For returning subjects, the process flows downward in FIG. 1 from start block 10. The returning subject's clinical trial is entered into the database (block 40), and the identification assigned to the subject for that study (the Sponsor Subject ID) is likewise entered (block 42) together with information regarding the type of visit. For the closing visit for a subject, the visit type is categorized as either being for a completion of the clinical trial or for early termination of the trial. The time differential between the first screening visit the last visit allows the present system to calculate the duration of enrollment for the subject in the clinical trial. This data can then be used by the present system in evaluating whether the subject meets the inclusion criteria for a later clinical trial for which the user might apply to participate in. Once the data is submitted (block 44), a confirmation of the visit information can be generated for the subject's file (block 46).

### Search Parameters

In order to screen for ineligible clinical study participants, the present method first determines whether a predetermined set of parameters match any records in the database. Depending on the matches found, the subject being evaluated is assigned a match status selected from (1) virtually certain, (2) probable, and (3) possible. Virtually certain matches are defined as those likely to occur at least 1 in 10 million times by chance. Probable matches are those likely to occur between 1 in one million and 1 in 10 million times by chance, and possible matches are those having an approximate likelihood of 1 in 100,000 to occur by chance.

When a virtually certain match is found, the information for the individual found to be a match in the clinical trial database is evaluated in order to determine whether that individual meets the inclusion criteria of the clinical trial in which the subject proposes to participate, and also to determine whether any predetermined exclusion criteria for the clinical trial are present. If the matched individual does not meet the inclusion criteria or does meet exclusion criteria for the clinical trial in which the subject proposes to participate, then the subject is preferably deemed to be ineligible for participation in the clinical trial and is excluded from the clinical trial. Subjects who are found to be probable or possible matches for individuals are also advantageously excluded from a clinical trial, although further investigation can also be performed in this case in order to provide greater certainty that the subject is in fact the individual who is matched in the clinical trial database.

Unless there is an exact match between all entered parameters for a subject and the data of an individual whose information is contained in the clinical trial database, in which case the match status would be virtually certain, the present methods determine whether there are any near matches in the database. For each near match, frequencies calculated through a demographic statistical analysis are used to assign a match status of probable, possible or virtually certain to such a near match. Because subjects trying to beat the system by enrolling on multiple studies may end up changing details about themselves, such as their initials or month or year of birth, the present search methodology evaluates near matches as well as exact matches.

The following parameters of a subject are searched according to the present method.

### (a) First, Middle & Last Initials

For many reasons, subjects may change their name from site to site. Apart from attempting to intentionally deceive the site, there may be other legitimate reasons for changing a subject's name, such as marriage, and therefore their initials, from one study to another. In order catch these subtle name changes, the present search method checks for the first initial parameter (i.e., the first letter of a subject's first name) against the first and second initials (the first letter of a subject's first name and middle name) in the database. As a result, instead of only three options for identifying a match of initials there are four:
The first initial of a queried subject's first name matches the first initial of the first name of a subject in the database (identified in the present application as an “FI” match).
The first initial of a queried subject's first name matches the first initial of the middle name of a subject in the database (identified in the present application as an “FI˜” match).
The first initial of a queried subject's middle name matches the middle initial of the first name of a subject in the database (identified in the present application as an “MI” match; if the subject provides no middle initial then this parameter is entered “-”).
The first initial of a queried subject's last name matches the first initial of the last name of a subject in the database (identified in the present application as an “LI” match).

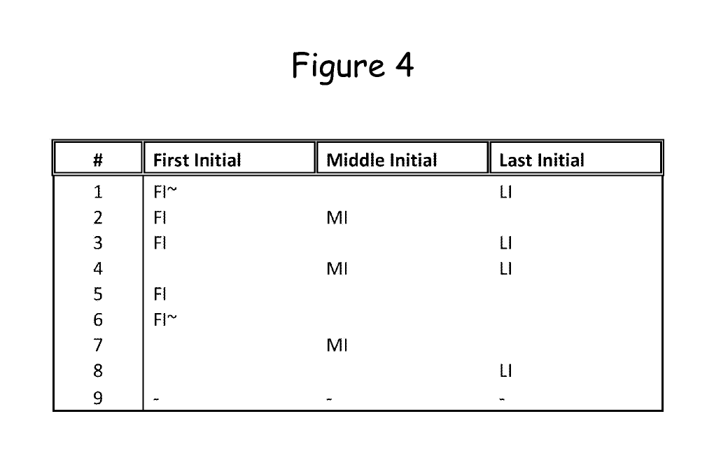

FIG. 4 illustrates the 9 possible combinations of these initials.

### (b) Date of Birth

The date of birth parameter is split into two separate parameters.
The day of birth and the month of birth (identified herein as “DOB—D/M”).
the date of birth year (identified herein as “DOB—Y”).

The reason the DOB parameter is split up is because a subject may sometimes change the day and month of their birth and keep the year the same or vice versa. The use of this parameter increases the chances of finding possible or probable matches even if the subject changes certain components of his or her birth date.

### (c) Gender, Height, Weight

The gender and height parameters are evaluated together at the beginning of the present search methodology. If subjects do not match gender and height within a predetermined amount, such as 5 centimeters, they are considered a “no match” and the search process proceeds no further. Since these two parameters cannot be falsified, beginning the search with these two parameters shortens the search process. In alternative embodiments, weight can also be used as a search criterion. However, because weight can vary significantly over time, it is less reliably correlated with identity.

### (d) Verified Identification Indicia

A portion of an alphanumeric identifier from a verified identification issued by a verified source can also be used in the present method, for example a partial social security number or a partial passport number. By using only a subset of the alphanumeric identifier's letters and/or numbers, preferably four consecutive digits of the alphanumeric identifier, the subject cannot be identified with the subset of letters and/or numbers, thereby protecting the subject's privacy. In a preferred embodiment, the last four digits of a social security or passport number are used. Alternatively, a driver's license or other verified identification document (in paper or electronic form) can be used. Preferably, only four consecutive digits of the alphanumeric identifier are used in the present search method, though alternative embodiments are contemplated in which 3, 5, or 6 consecutive digits are searched. The alphanumeric itself, from which the consecutive digits are derived, is preferably at least four digits long, more preferably six digits long, even more preferably 7 or 8 digits long, and even more preferably at least 9 digits long.

### Search Process

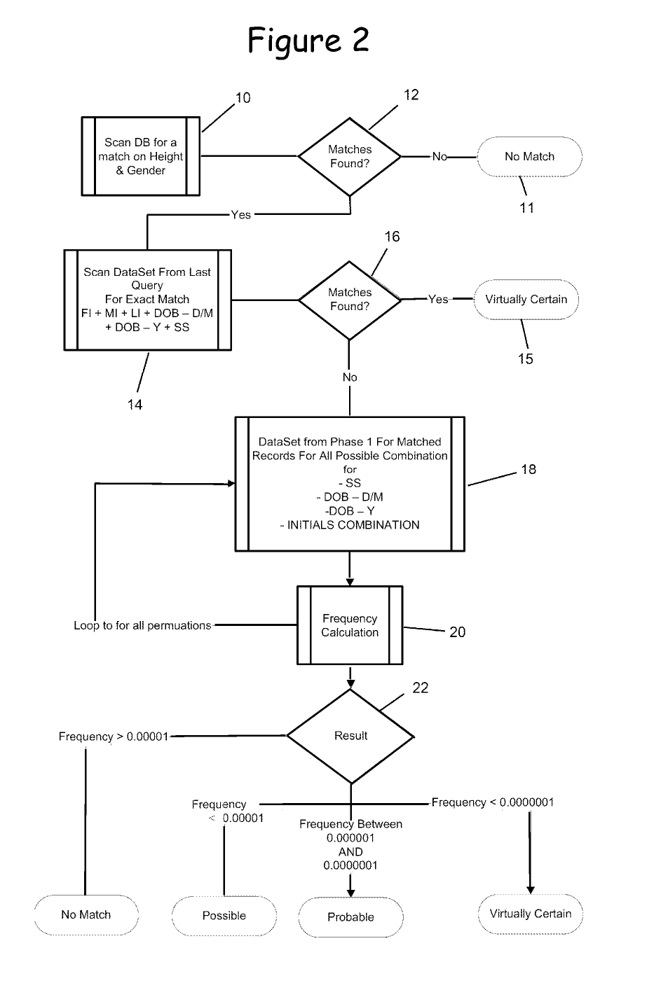

As shown in the process flow diagram of FIG. 2, in the first phase of the search methodology used in the present process, the process determines if there are any matches for the height and gender parameter(s) in the database (blocks 10 and 12). This is the lowest criteria. If there are no matches for the combined height and gender parameter, then the process determines a match status of “no match” with records in the database (block 11). In addition to identifying exact height and gender matches, matches within 5 cm and/or 3% of a height in the database, or alternatively within 4 centimeters or within 2%, can also be considered matches, due to variation or errors in measuring a subject. For example, a height plus or minus 5 centimeters of a height recorded in the database can be used in the present method as a match for a height parameter.

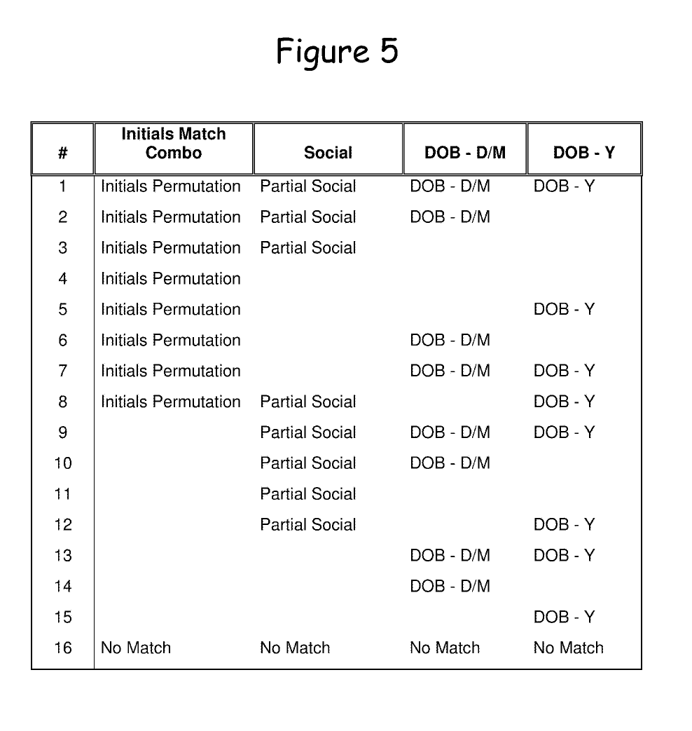

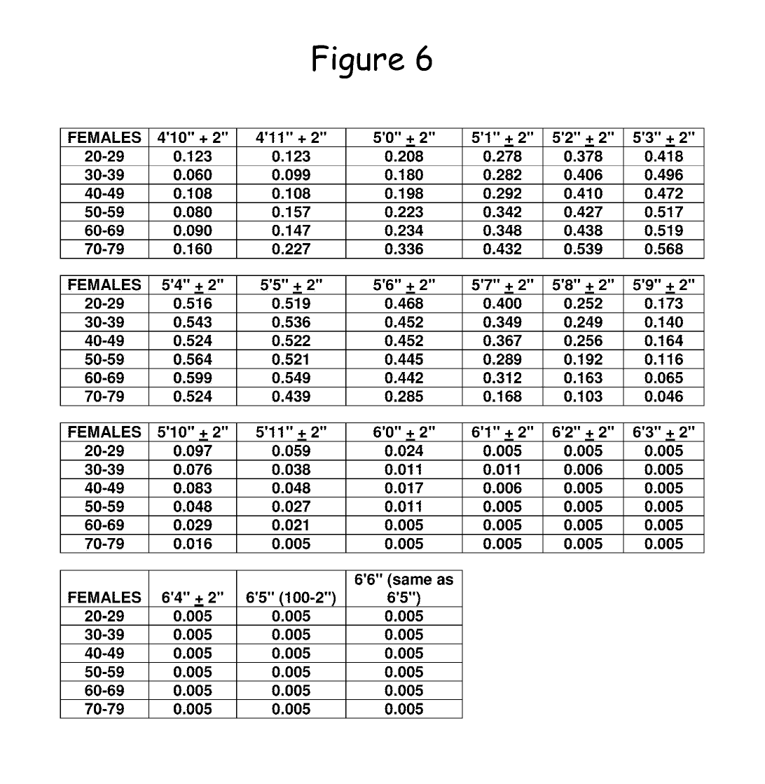

If records are returned from matching the height and gender of a subject, then the search method determines whether an exact match can be found in addition with the remaining 6 parameters shown in block 14, namely the first initial, middle initial, last initial, day and month of birth, year of birth, and verified identifier (with “SS referring to a partial social security number). If an exact match can be found (block 16), then the search logic need not go any further, and a match status of “virtually certain” can be assigned and a search report printed out (block 15). If an exact match cannot be found, the search proceeds to the next step, in which all the parameter permutations in the table shown in FIG. 5 are compared against the database to see which ones return records.

There are 16 possible combinations with the name variable along with verified identification (e.g., a partial social security number), DOB—D/M (day and month of birth) and DOB—Y (year of birth), as shown in FIG. 5. When combined with the 9 possible combinations for the initials as listed in the table of FIG. 4, there are a possible 144 combinations for all 8 parameters. For each combination of parameters, the search logic determines whether any records are returned.

For all combinations where records are found, the next step is to obtain the Frequency calculation for each iteration. For all matches found in the foregoing step, the system must determine a frequency number that indicates how certain it is that the matched record is referring to the correct subject. In essence, the smaller the number, the more certain the system is that it has found a viable match to the entered parameters.

The frequency number for all parameters will be stored in predefined static tables (block 18). The frequency of certain parameters, such as the frequency of four digits occurring in a portion of a number associated with an verified identification, such as the last 4 digits of a social security number, is a fixed integer (i.e., the possible combination of four numbers is going to be 1 in 10,000). For other parameters, the frequency of the information will be a predetermined number based on reliable information. For example, the frequency of a year of birth in a population will be based on the census or other reliably gathered information concerning a population of which the clinical study participants are members or concerning a population which is representative of the clinical study participants. Frequency calculations can be computed as follows:

(Frequency of First Initial in either first or second position)×(Frequency of Middle Initial in either the first or second position)×(Frequency of Last initial)×(Frequency of Day and Month of birth)×(Frequency of Year of birth)×(Frequency of Gender)×(Frequency of 4 digits or characters of a verified identification)=Final Frequency Result

When the frequency calculations are made (block 20), only the frequency of those parameters for which a match is found (block 16) are included in the frequency calculations (see example 1 below, for example). If the calculated frequency (the product of the frequency calculation) is >0.0001, then the present system will not identify the subject as matching any database entries corresponding to participants in other clinical trials. If the calculated frequency is <0.00001, then the subject is identified with the match status of being a possible match with a participant in another clinical trial in the database. If the calculated frequency is between 0.00001 and 0.000001, then the subject is identified as a probable match with a participant in another clinical trial in the database. If the calculated frequency is <0.000001, then the subject is identified as a virtually certain match with a participant in another clinical trial in the database.

If a subject is identified as a possible, probably, or virtually certain match, the present system then preferably evaluates whether the participant in another clinical trial who is matched to the subject would be eligible to participate in the clinical trial in which the subject is proposing to participate, or otherwise provides a user of the present system with any inclusion and exclusion criteria for the clinical trial so that the user can make this evaluation. When appropriate matches are found by the present process, further actions can be taken depending on subject inclusion and exclusion criteria established for a particular study. Each study has individual criteria for what types of subjects should be allowed to enroll and the prerequisites that have to be met. Such criteria can include, for example, DSLSP (Days Since Last Study Participation), diagnosis with a particular disorder, and BMI (body mass index) score.

### Computer Systems

The present method can be performed by a computer system, which can include a processing circuit coupled to a storage medium, a communications interface and a display. The computer system can be operated by instructions in a computer readable medium encoded with computer readable program code. It is noted that additional, fewer and/or different features and components can be included in computer system according to various embodiments.

The processing circuit is arranged to obtain, process and/or send data, control data access and storage, issue commands, and control other desired operations. The processing circuit can comprise circuitry configured to implement desired programming provided by appropriate media in at least one embodiment. For example, the processing circuit can be implemented as one or more of a processor, a controller, a plurality of processors and/or other structure configured to execute executable instructions including, for example, software and/or firmware instructions, and/or hardware circuitry. Embodiments of the processing circuit can include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor can be a microprocessor but, in the alternative, the processor can be any conventional processor, controller, microcontroller, or state machine. A processor can also be implemented as a combination of computing components, such as a combination of a DSP and a microprocessor, a number of microprocessors, one or more microprocessors in conjunction with a DSP core, or any other such configuration. These examples of the processing circuit are for illustration and other suitable configurations within the scope of the present disclosure are also contemplated.

The storage medium can represent one or more devices for storing programming and/or data, such as executable code or instructions (e.g., software, firmware), electronic data, databases, or other digital information. The storage medium can be any available media that can be accessed by a general purpose or special purpose processor. By way of example and not limitation, the storage medium can include read-only memory (ROM), random access memory (RAM), magnetic disk storage mediums, optical storage mediums, flash memory devices, and/or other non-transitory computer-readable mediums for storing information. The storage medium can be coupled to the processing circuit such that the processing circuit can read information from, and write information to, the storage medium. In the alternative, the storage medium can be integral to the processing circuit.

The communications interface is configured to implement wireless and/or wired communications of computer system. For example, in some embodiments, the communications interface can be configured to communicate information bi-directionally with respect to one or more remote devices as well as other devices by means of a communication network (e.g., communication network in FIG.). The communications interface can be coupled with an antenna and can include wireless transceiver circuitry for wireless communications with wireless devices and can also include as a network interface card (NIC), serial or parallel connection, USB port, Firewire interface, flash memory interface, floppy disk drive, or any other suitable arrangement for communicating with respect to public (e.g., Internet) and/or private networks or other wired arrangements.

The display is configured to visually present images to a user (e.g., a list of software programs). For example, the display can include a monitor, television, projector, or other device for visually presenting graphics to a user.

### EXAMPLES

### Example 1

### Database Search

The following parameters were entered in the present system for a search:
Initials: J-S
Gender: Male
Height: 5′-9″
Social: 4678
DOB: 15 Sep. 1960

The following match is found.
Gender: Male

A match is therefore found with the entered parameter for gender. The following matches are then found in the second step of the present process:
Height: 5′-11″. Matches within 4 centimeters of entered height parameter.
Initials: FJS (FI˜, LI)

The search also reveals the following:
DOB 13 Apr. 1960
Social Security: 3456

Only the year matches for data of birth. No match with social security number.

In order to calculate the frequency of this Match Record we execute the following calculation:

(Frequency of First Initial being a “J”)×(Frequency of Last Initial Being an “S”)×(Frequency of Gender being a Male)×(Frequency of height being 5′-11″)×(Frequency of year of birth being 1962)=FINAL FREQUENCY RESULT.

Based on the Frequency Result, the search method assigns each matched record a match status, as described above.

### Example 2

### Evaluation of CNS Studies

1100 subjects participating in clinical trials for CNS (central nervous system) pharmaceutical agents at nine sites were entered into a database and subjected to the present screening process.

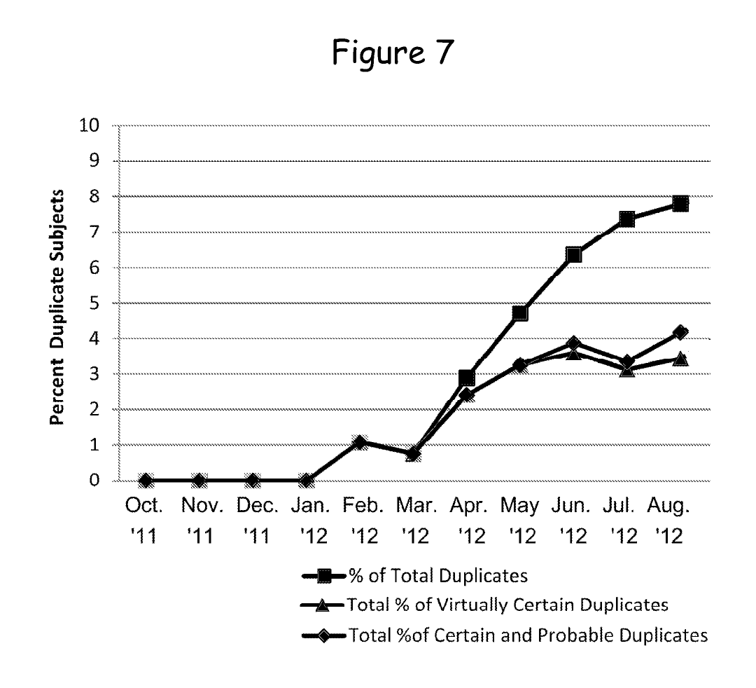

As a result of the use of the present process, site collaboration/use of trial subject registry reduced the number of duplicate subjects entering studies from participating sites. Only 9 CNS sites participated in only one region, and subjects were free to “shift” to non-participating sites or regions other regions/non-CNS. In this pilot study, 3.45% of prescreens were certain duplicates. When probables are included, this number increased to 4.35%. Results are shown in FIG. 7.

At least some implementations herein have been described as a process that is depicted as a flowchart, a flow diagram, a structure diagram, or a block diagram. Although a flowchart may describe the operations as a sequential process, many of the operations can be performed in parallel or concurrently. In addition, the order of the operations can be re-arranged. A process is terminated when its operations are completed. A process can correspond to a method, a function, a procedure, a subroutine, a subprogram, etc. When a process corresponds to a function, its termination corresponds to a return of the function to the calling function or the main function.

Moreover, embodiments can be implemented by hardware, software, firmware, middleware, microcode, or any combination thereof. When implemented in software, firmware, middleware or microcode, the program code or code segments to perform the necessary tasks can be stored in a machine-readable medium such as a non-transitory storage medium or other storage(s). A processor can perform the necessary tasks. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted via any suitable means including memory sharing, message passing, token passing, network transmission, etc.

Those of skill in the art would further appreciate that the various illustrative logical blocks, modules, circuits, and steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Furthermore, programming adapted to perform one or more of the various steps or processes described creates a new machine, because a general purpose computer in effect becomes a special purpose computer once it is programmed to perform particular functions pursuant to instructions from program software. Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure.

Recitation of value ranges herein is merely intended to serve as a shorthand method for referring individually to each separate value falling within the range. Unless otherwise indicated herein, each individual value is incorporated into the specification as if it were individually recited herein. All references cited herein are incorporated by reference in their entirety.

1. A method operational in a computer system, comprising:
(a) receiving personal identifying information from a subject proposed for inclusion in the first clinical trial, the personal identifying information comprising:
(i) initials of the subject, wherein the initials comprise the first letter of a first name of the subject, the first letter of a middle name of the subject, and the first letter of a last name of the subject;
(ii) day, month, and year of birth of the subject;
(iii) 4 consecutive characters of a verified identification; and
(iv) height and gender of a study participant;
(b) comparing the height and gender of the proposed subject to height and gender information in a database, the database comprising the personal identifying information of a plurality of clinical trial subjects participating in one or more other clinical trials;
(c) if the height and gender of the proposed subject matches the height and gender of one or more enrolled clinical trial subjects, then the following personal identifying information of the proposed subject are compared with corresponding personal identifying information of the enrolled clinical trial subjects:
(i) first initial;
(ii) second initial;
(iii) last initial;
(iv) day and month of birth;
(v) year of birth; and
(vi) four consecutive digits of an alphanumeric identifier of a verified identification;
(d) if all the items of personal identifying information listed in step (c) of the proposed subject match the same items of personal identifying information of an enrolled clinical trial subject, then identifying the subject pursuant to step (g);
(e) if some of the items of personal identifying information listed in step (c) of the proposed subject do not match the same items of personal identifying information of an individual enrolled clinical trial subject, then obtaining frequency information for each of the items of personal identifying information listed in step (c) of the proposed subject which do match the same items of personal identifying information of an enrolled clinical trial subject, wherein the frequency information is derived from a predetermined data set and comprises the following:
(i) frequency of first initial of a subject as either the first initial or second initial of an enrolled clinical trial subject;
(ii) frequency of middle initial of a subject as either the first initial or second initial of an enrolled clinical trial subject;
(iii) frequency of last initial of a subject as last initial of an enrolled clinical trial subject;
(iv) frequency of day and month of birth of a subject;
(v) frequency of year of birth of a subject;
(vi) frequency of gender; and
(vii) frequency of four consecutive alphanumeric digits used in an alphanumeric identifier of a verified identification;
(f) multiplying the frequency information for each of the items of personal identifying information listed in step (c) of the proposed subject which match the same items of personal identifying information of an enrolled clinical trial subject, thereby obtaining a product of the frequencies, wherein if the product is <0.00001, then identifying the subject pursuant to step (g);
(g) identifying the subject as possibly matching a clinical trial subject participating in one or more other clinical trials.

2. The method of claim 1, wherein the product is between 0.00001 and 0.0000001.

3. The method of claim 2, wherein the product is <0.000001.

4. The method of claim 1, wherein height of the proposed subject is deemed to match the height of one or more enrolled clinical trial subjects if it is within 5 centimeters of the height of one or more enrolled clinical trial subjects in the database.

5. A computer system for use in the method of claim 1, comprising:
a display device;
a communication interface; and
a processing circuit coupled to the display device and the communication interface, the processing circuit being adapted to receive the data from step (a) and perform steps (b) through (g).

6. The computer system of claim 5, wherein the computer system comprises a server.

7. A computer readable medium encoded with computer readable program code, the program code comprising instructions operable to perform the method of claims 1.

8. The computer readable medium of claim 7, wherein the computer readable memory is a storage medium in communication with the processing circuit.

9. A process for identifying individuals ineligible to participate in a first clinical trial, comprising the steps of:
(a) obtaining personal identifying information from a subject proposed for inclusion in the first clinical trial, the personal identifying information comprising:
(i) initials of the subject, wherein the initials comprise the first letter of a first name of the subject, the first letter of a middle name of the subject, and the first letter of a last name of the subject;
(ii) day, month, and year of birth of the subject;
(iii) 4 consecutive characters of a verified identification; and
(iv) height and gender of a study participant;
(b) entering the personal identifying information of the proposed subject into a database, wherein the database comprises the personal identifying information of a plurality of clinical trial subjects participating in one or more other clinical trials;
(c) comparing the height and gender of the proposed subject to the height and gender of the enrolled clinical trial subjects;
(d) if the height and gender of the proposed subject matches the height and gender of one or more enrolled clinical trial subjects, then the following personal identifying information of the proposed subject are compared with corresponding personal identifying information of the enrolled clinical trial subjects:
(i) first initial;
(ii) second initial;
(iii) last initial;
(iv) day and month of birth;
(v) year of birth; and
(vi) four consecutive digits of an alphanumeric identifier of a verified identification;
(e) if all the items of personal identifying information listed in step (d) of the proposed subject match the same items of personal identifying information of an enrolled clinical trial subject, then evaluating the subject pursuant to step (h);
(f) if some of the items of personal identifying information listed in step (d) of the proposed subject do not match the same items of personal identifying information of an enrolled clinical trial subject, then obtaining frequency information for each of the items of personal identifying information listed in step (d) of the proposed subject which do match the same items of personal identifying information of an enrolled clinical trial subject, wherein the frequency information is derived from a predetermined data set and comprises the following:
(i) frequency of first initial of a subject as either the first initial or second initial of an enrolled clinical trial subject;
(ii) frequency of middle initial of a subject as either the first initial or second initial of an enrolled clinical trial subject;
(iii) frequency of last initial of a subject as last initial of an enrolled clinical trial subject;
(iv) frequency of day and month of birth of a subject;
(v) frequency of year of birth of a subject;
(vi) frequency of gender; and
(vii) frequency of four consecutive alphanumeric digits used in an alphanumeric identifier of a verified identification;
(g) multiplying the frequency information for each of the items of personal identifying information listed in step (d) of the proposed subject which match the same items of personal identifying information of an enrolled clinical trial subject, thereby obtaining a product of the frequencies, wherein if the product is <0.00001, then evaluating the subject pursuant to step (h);
(h) evaluating information in the database concerning the enrolled clinical trial subject who matches the subject and determining whether the subject is eligible to participate in first the clinical trial.

10. The method of claim 1, wherein the product is between 0.00001 and 0.0000001.

11. The method of claim 2, wherein the product is <0.000001.

12. The method of claim 1, wherein height of the proposed subject is deemed to match the height of one or more enrolled clinical trial subjects if it is within 5 centimeters of the height of one or more enrolled clinical trial subjects in the database.
